(19) United States
(12) Patent Application Publication
(10) Pub. No.: US 2015/0046546 A1
(43) Pub. Date: Feb. 12, 2015

(54) SEPARATING AND SENDING PRIVATE TEXT FROM AN ELECTRONIC MESSAGE

(71) Applicant: International Business Machines Corporation, Armonk, NY (US)

(72) Inventors: Andrea W. Bailey, Clayton, NC (US); Ethan G. Holder, Raleigh, NC (US); David B. Roberts, Cary, NC (US); David M. Roth, Durham, NC (US)

(73) Assignee: International Business Machines Corporation, Armonk, NY (US)

(21) Appl. No.: 13/964,250

(22) Filed: Aug. 12, 2013

Related U.S. Application Data
(63) Continuation of application No. 13/963,012, filed on Aug. 9, 2013.

(51) Int. Cl. H04L 12/58

(52) U.S. Cl. CPC H04L 51/14
USPC 709/206

(57) ABSTRACT

A method comprising receiving an original message from a sender, wherein the original message includes multiple portions of content and designates one or more recipients for each of the portions of content, wherein at least one of the portions of content is designated for multiple recipients. The method further comprises automatically, in response to receiving the original message from the sender, preparing a separate message designated for each recipient, wherein the separate message designated for a particular one of the recipients includes only those portions of content from the original message that are designated for the particular recipient. The method still further comprises forwarding each of the separate messages to the designated recipient.

### CROSS-REFERENCE TO RELATED APPLICATIONS

This application is a continuation of U.S. patent application Ser. No. 13/963,012 filed on Aug. 9, 2013, which application is incorporated by reference herein.

### BACKGROUND

1. Field of the Invention

The present invention relates to the preparation, transmission, and receipt of messages from one computer to another.

2. Background of the Related Art

Electronic messaging is a very convenient form of communication. Current popular forms of electronic messaging include email and text messaging. A person can author a message on a first electronic device, such as a computer or telephone, and send the message to one or more person using a destination address, such as an email address or a telephone number. The person authoring the message can prepare and review their message prior to sending and can include, for example, text, images, links and files. Transmission of the message to the intended recipient may occur very quickly. Furthermore, the electronic message typically facilitates a reply message, such that recipient can send a reply without entry of the destination address.

A person may wish to send a message to multiple recipients, yet desire to include customize the content to individual recipients. This may, for example, be done by copying and pasting content from one message to another in order to send each recipient a unique message. However, this can require a significant amount of time and effort, perhaps including steps to attach some of the same files to multiple messages. Furthermore, the multiple separate messages are not associated in any manner, such that reply messages from the multiple recipients will not be associated with each other.

### BRIEF SUMMARY

One embodiment of the present invention provides a method, comprising: receiving an original message from a sender, wherein the original message includes multiple portions of content and designates one or more recipients for each of the portions of content, wherein at least one of the portions of content is designated for multiple recipients; automatically, in response to receiving the original message from the sender, preparing a separate message designated for each recipient, wherein the separate message designated for a particular one of the recipients includes only those portions of content from the original message that are designated for the particular recipient; and forwarding each of the separate messages to the designated recipient.

### BRIEF DESCRIPTION OF THE SEVERAL VIEWS OF THE DRAWINGS

FIG. 1 is a conceptual diagram illustrating the methods of the present invention.

FIG. 2 is a diagram of a computer 102 that may be utilized in accordance with one or more embodiments of the present invention.

FIG. 3 is a flowchart of a method in accordance with one embodiment of the present invention.

### DETAILED DESCRIPTION

One embodiment of the present invention provides a method, comprising receiving an original message from a sender, wherein the original message includes multiple portions of content and designates one or more recipients for each of the portions of content, wherein at least one of the portions of content is designated for multiple recipients. The method further comprises automatically, in response to receiving the original message from the sender, preparing a separate message designated for each recipient, wherein the separate message designated for a particular one of the recipients includes only those portions of content from the original message that are designated for the particular recipient. The method still further comprises forwarding each of the separate messages to the designated recipient.

The method may, for example, be implemented in an intermediary system, such as messaging service. A messaging service may be an email service provider running on an email server or a text message service provider that operates on a text messaging server on a phone network. Alternatively, the method may be implemented in a downstream module of a local email program or web service used by the sender, such as an outgoing email filter.

The original message may be prepared in a local email program, a web-based email service, or a text messaging application on a telephone, including some type of text editor or other messaging interface. The portions of content may be any type or size. Examples of the types of content portions include, without limitation, text, links, images and files. The size of a link, image or file may be determined by the nature of the link, image or file, and the size of text in a content portion may be, without limitation, a single alphanumeric character or symbol, a word, phrase, sentence, paragraph, section, and the like.

Each portion of content may be designated for one or more recipient. Such a designation may take the form of a flag, tag or other text or logical association with the portion of content. One method of designating recipients of a particular portion of content, includes placing a start tag at the beginning of the portion of content, an end tag at the end of the portion of content, and identifying the one or more recipients somewhere between the start tag and end tag. For example, a portion of content may be designated to be sent to recipient A and recipient B as follows: “[/A/B Content]”. It should be recognized that a portion of content may be designated for a single individual recipient or a group of recipients, such as a designation for all recipients identified in the original message. Optionally, each of the separate messages may only identify the particular recipient, and not identify any other of the recipients of separate messages that were generated as the result of a common original message.

Since each separate message is designated for a particular recipient, and includes only those portions of content from the original message that are designated for the particular recipient, the recipient will receive a message containing only the content that was designated for them. Since the separate message does not contain other content (i.e., content that was not designated for them), it is impossible for the recipient to manipulate the message or use alternative means to recover content that was not intended for the recipient. This increases the security of the messaging system. Furthermore, it is not necessary for the recipient's messaging system or program to filter content from the message. This simplifies the recipient's message system or program.

In a further embodiment of the invention, multiple reply messages may be received, wherein each reply message is received from a recipient in reply to one of the separate messages. Each reply message is forwarded the sender with an indication that the reply message is associated with the original message. This indication is beneficial to the sender of the original message, because all the replies can be identified in relation to the original message without having to manually hunt for a reply from each recipient.

In a still further embodiment of the invention, the original message may be displayed to the sender on a display device while the sender is preparing the original message. Furthermore, a preview message may be selectively displaying on the display device before the sender finalizes the original message, wherein the preview message includes only those portions of content from the original message that are designated for a particular recipient. In order to provide the preview message, the sender's computer or other electronic device will preferably include the messaging service, or much of the functionality of the messaging service, in accordance with the present invention.

Another embodiment of the present invention provides a computer program product including computer readable program code embodied on a computer readable storage medium. The computer program product comprises: computer readable program code for receiving an original message from a sender, wherein the original message includes multiple portions of content and designates one or more recipients for each of the portions of content, wherein at least one of the portions of content is designated for multiple recipients; computer readable program code for automatically, in response to receiving the original message from the sender, preparing a separate message designated for each recipient, wherein the separate message designated for a particular one of the recipients includes only those portions of content from the original message that are designated for the particular recipient; and computer readable program code for forwarding each of the separate messages to the designated recipient.

The foregoing computer program products may further include computer readable program code for implementing or initiating any one or more aspects of the methods described herein. Accordingly, a separate description of the methods will not be duplicated in the context of a computer program product.

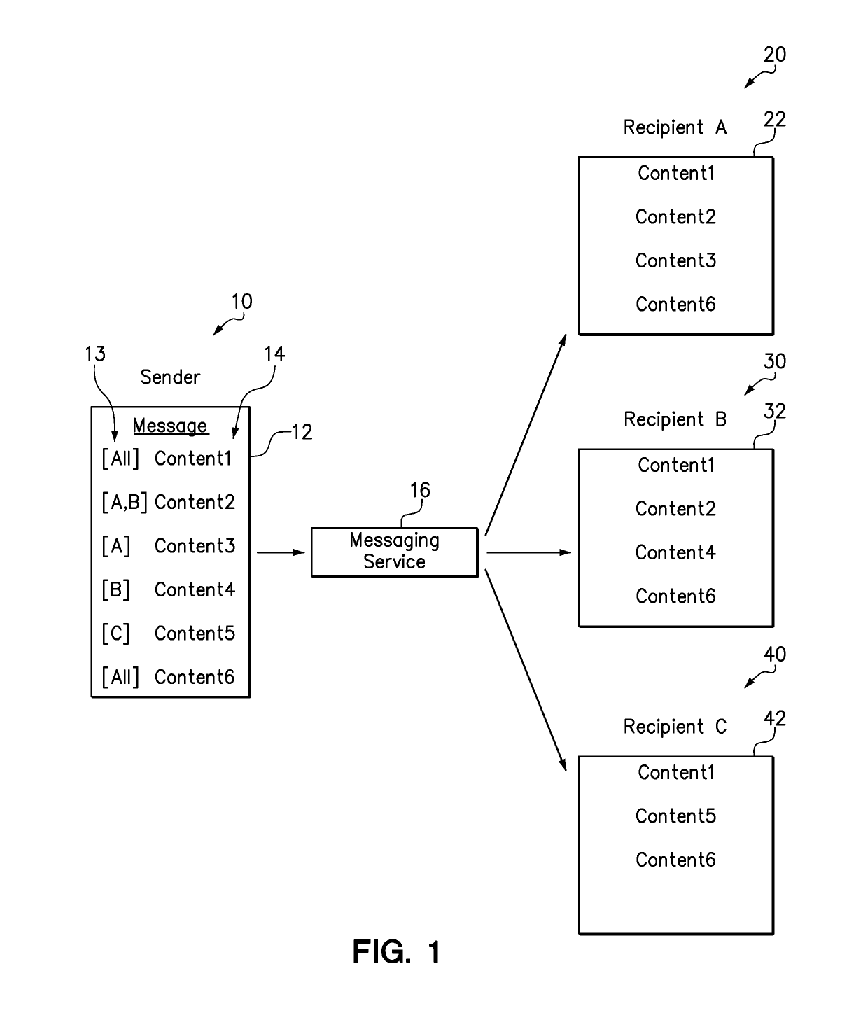

FIG. 1 is a conceptual diagram illustrating the methods of the present invention. In this example, a sender 10 authors or composes an original message 12 including various portions of content 14, which are labeled Content 1 through Content 6. Adjacent to, or otherwise associated with, Content 1 through Content 6 is a tag 13 that designates one or more recipient of that portion of content. As shown, Content 1 is designated for “All” recipients mentioned in the message, which includes Recipient A, Recipient B and Recipient C. Content 2 is designated for Recipient A and Recipient B; Content 3 is designated for Recipient A; Content 4 is designated for Recipient B; Content 5 is designated for Recipient C; and Content 6 is designated for (“All”) Recipient A, Recipient B and Recipient C. When the sender 10 has completed the original message 12, it may be submitted to the messaging service 16.

The messaging service 16 receives the original message from the sender 10, wherein the original message includes six portions of content and designates one, two, or all recipients for each of the portions of content. In response to receiving the original message from the sender, the messaging service 16 prepares a separate message designated for each recipient, wherein the separate message designated for a particular one of the recipients includes only those portions of content from the original message 12 that are designated for the particular recipient. These separate messages are then forwarded to the designated recipient. As shown, Recipient A 20 has received a separate message 22 that includes Content 1, Content 2, Content 3 and Content 6; Recipient B 30 has received a separate message 32 that includes Content 1, Content 2, Content 4 and Content 6; and Recipient C 40 has received a separate message 42 that includes Content 1, Content 5 and Content 6. Typically, the sender will prepare the original message on a first computer, telephone or other electronic messaging device, and each recipient will view their separate message on a separate computer, telephone or other electronic messaging device.

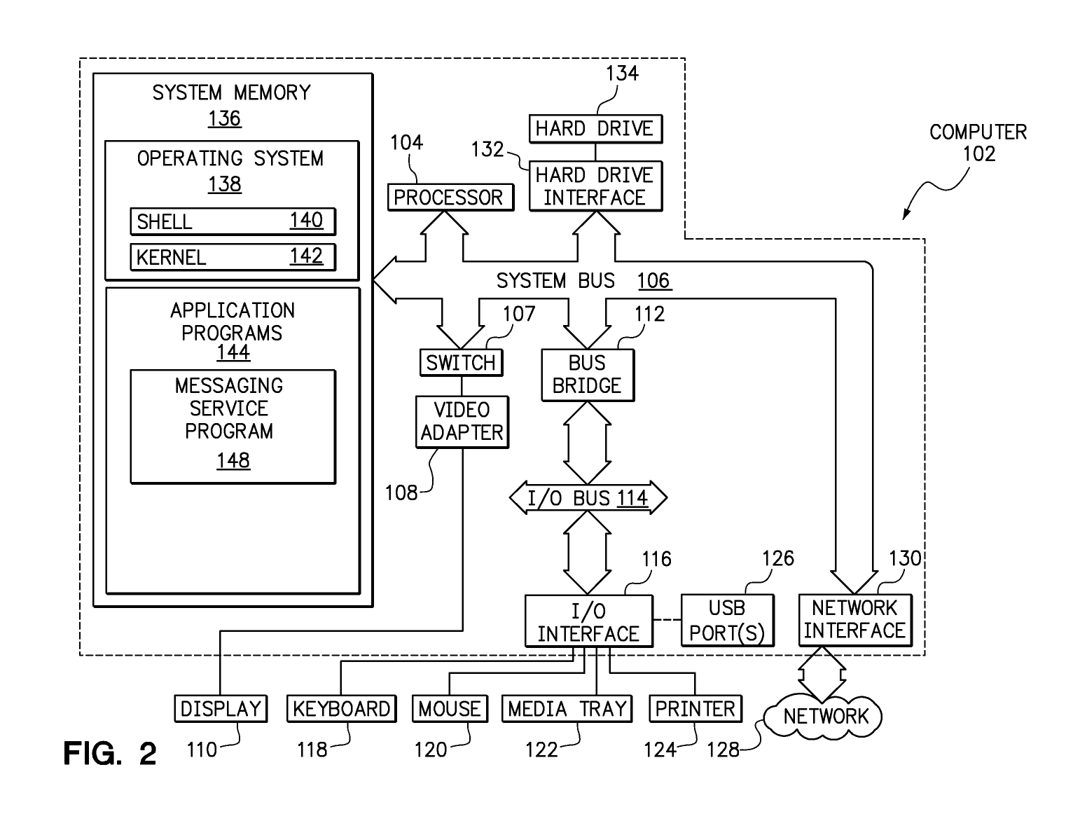

FIG. 2 is a diagram of an exemplary computing node (or simply “computer”) 102 that may be utilized in accordance with one or more embodiments of the present invention. Note that some or all of the exemplary architecture, including both depicted hardware and software, shown for and within computer 102 may be implemented in the service provider computer 102 as shown in FIG. 1.

Computer 102 includes a processor unit 104 that is coupled to a system bus 106. Processor unit 104 may utilize one or more processors, each of which has one or more processor cores. A video adapter 108, which drives/supports a display 110, is also coupled to system bus 106. In one embodiment, a switch 107 couples the video adapter 108 to the system bus 106. Alternatively, the switch 107 may couple the video adapter 108 to the display 110. In either embodiment, the switch 107 is a switch, preferably mechanical, that allows the display 110 to be coupled to the system bus 106, and thus to be functional only upon execution of instructions that support the processes described herein.

System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and (if a VHDL chip 137 is not utilized in a manner described below), external USB port(s) 126. While the format of the ports connected to I/O interface 116 may be any known to those skilled in the art of computer architecture, in a preferred embodiment some or all of these ports are universal serial bus (USB) ports.

As depicted, the computer 102 is able to communicate over a network 128 using a network interface 130. Network 128 may be an external network such as the Internet, or an internal network such as an Ethernet or a virtual private network (VPN).

A hard drive interface 132 is also coupled to system bus 106. Hard drive interface 132 interfaces with a hard drive 134. In a preferred embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102′s operating system (OS) 138 and application programs 144.

The operating system 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management. Application programs 144 in the system memory of computer 102 may include a messaging service program 148 for implementing the methods described herein.

The hardware elements depicted in computer 102 are not intended to be exhaustive, but rather are representative components suitable to perform the processes of the present invention. For instance, computer 102 may include alternate memory storage devices such as magnetic cassettes, digital versatile disks (DVDs), Bernoulli cartridges, and the like. These and other variations are intended to be within the spirit and scope of the present invention.

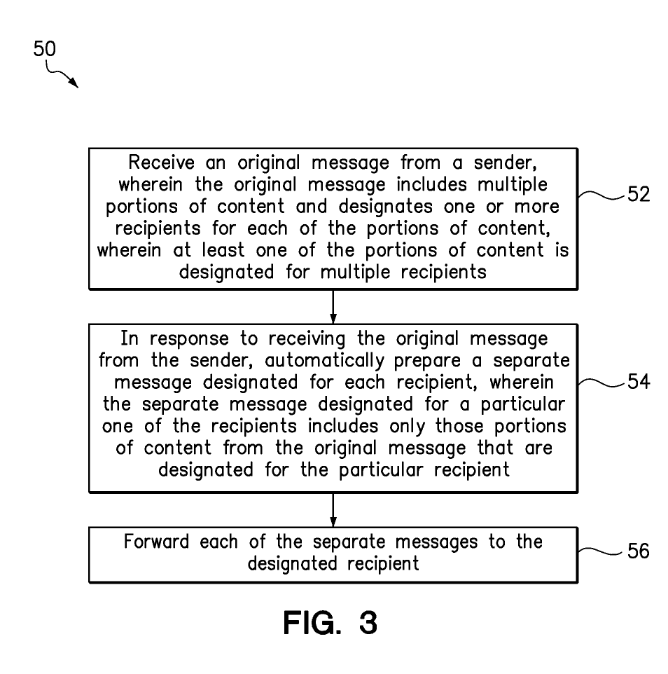

FIG. 3 is a flowchart of a method 50 for handling messages in accordance with one embodiment of the present invention. In step 52, an original message is received from a sender, wherein the original message includes multiple portions of content and designates one or more recipients for each of the portions of content, wherein at least one of the portions of content is designated for multiple recipients. In step 54, a separate message designated for each recipient is automatically prepared in response to receiving the original message from the sender, wherein the separate message designated for a particular one of the recipients includes only those portions of content from the original message that are designated for the particular recipient. Then, in step 56, the method forwards each of the separate messages to the designated recipient.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method, comprising:
a sender preparing an original message on a first computer;
receiving the original message from the sender, wherein the original message includes multiple portions of content and designates one or more recipients for each of the portions of content, wherein at least one of the portions of content is designated for multiple recipients;
automatically, in response to receiving the original message from the sender, preparing a separate message designated for each recipient, wherein the separate message designated for a particular one of the recipients includes only those portions of content from the original message that are designated for the particular recipient;
forwarding each of the separate messages to the designated recipient;
each recipient viewing one of the separate messages on a separate computer;
receiving multiple reply messages, wherein each reply message is received in reply to one of the separate messages; and
forwarding each reply message to the sender with an indication that the reply message is associated with the original message.

2. (canceled)

3. The method of claim 1, wherein the messages are selected from email messages and text messages.

4. The method of claim 1, wherein each of the separate messages does not identify any other of the recipients.

5. (canceled)

6. The method of claim 1, further comprising:
displaying the original message to the sender on a display device while the sender is preparing the original message; and
selectively displaying a preview message on the display device before the sender finalizes the original message, wherein the preview message includes only those portions of content from the original message that are designated for a particular recipient.

7. The method of claim 1, wherein the original message is received by a messaging service running on a server, and wherein the messaging service prepares and forwards the separate messages to the recipients.
